(19) United States
(12) Patent Application Publication
(10) Pub. No.: US 2026/0292528 A1
(43) Pub. Date: Sep. 24, 2026

(54) RANGE EXTENSION FOR ELECTRONIC DEVICES

(71) Applicant: Apple Inc., Cupertino, CA (US)

(72) Inventors: Arun Vijayakumari MAHASENAN, Fremont, CA (US); Sudhir K. BAGHEL, Pleasanton, CA (US); Venkateswara Rao MANEPALLI, San Jose, CA (US)

(21) Appl. No.: 19/088,891

(22) Filed: Mar. 24, 2025

(51) Int. Cl. H04W 16/26

(52) U.S. Cl. CPC H04W 16/26

(57) ABSTRACT

The subject technology provides range extension for wireless communications from a device, without modification to the wireless hardware of the device. Range extension operations can be performed, in software, at a transmitting device and/or at a receiving device. Range extension operations at a transmitting device may include reducing a symbol space in which data to be transmitted is represented, by modifying the data itself prior to signal modulation. Range extension operations at a receiving device may include accumulating frames with errors, and estimating an original frame from the accumulated frames.

### TECHNICAL FIELD

The present description generally relates to wireless communication and, in particular, for example, to range extension for electronic devices.

### BACKGROUND

Electronic devices are often provided with radio components for transmission of wireless signals. Radio components typically have a range that is limited by the physical hardware of the radio components.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates a block diagram of an example system for wireless communication in accordance with one or more implementations.

FIG. 3 is a block diagram illustrating sending device operations for range extension in accordance with one or more implementations.

FIG. 4 illustrates a modification of a bitstream for range extension in accordance with one or more implementations.

FIG. 5 is a block diagram illustrating other exemplary sending device operations for range extension in accordance with one or more implementations.

FIG. 6 is a block diagram illustrating exemplary receiving device operations for range extension in accordance with one or more implementations.

FIG. 7 is a block diagram illustrating other exemplary receiving device operations for range extension in accordance with one or more implementations.

FIG. 8 illustrates an error correction operation that may be performed by a receiving device for range extension in accordance with one or more implementations.

FIG. 9 is a flow chart of an example process that may be performed for range extension by a sending device in accordance with one or more implementations.

FIG. 10 is a flow chart of an example process that may be performed for range extension by a receiving device in accordance with one or more implementations.

FIG. 11 is a flow chart of another example process that may be performed for range extension by a receiving device in accordance with one or more implementations.

FIG. 12 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology can help to extend the range of wireless communications, including for low-rate wireless personal area network (LR-WPAN, as defined in IEEE 802.15.4) communications, such as Thread® or Zigbee communications, without modifying existing radio hardware in a device. In one or more implementations, range extension operations can be performed, in software, at a transmitting (sending) device and/or at a receiving device. Range extension operations at a transmitting device may include reducing a symbol space in which data to be transmitted is represented, by modifying the data itself (e.g., in software) prior to signal modulation. Range extension operations at a receiving device may include accumulating frames with errors and estimating an original frame from the accumulated frames with errors. Extending the range in these ways may be helpful in various range extension conditions, such as an emergency mode of operation (e.g., an SOS mode, in which a device is sending a help signal for detection by nearby devices), a low signal strength condition, and/or a high error rate condition. These range extension conditions may occur more frequently when certain radio technologies (e.g., Thread, Zigbee) are included in portable devices, such as smartphones, that change their locations, in addition to stationary devices (e.g., smart speakers, set top boxes, and IoT devices) that commonly include those radio technologies.

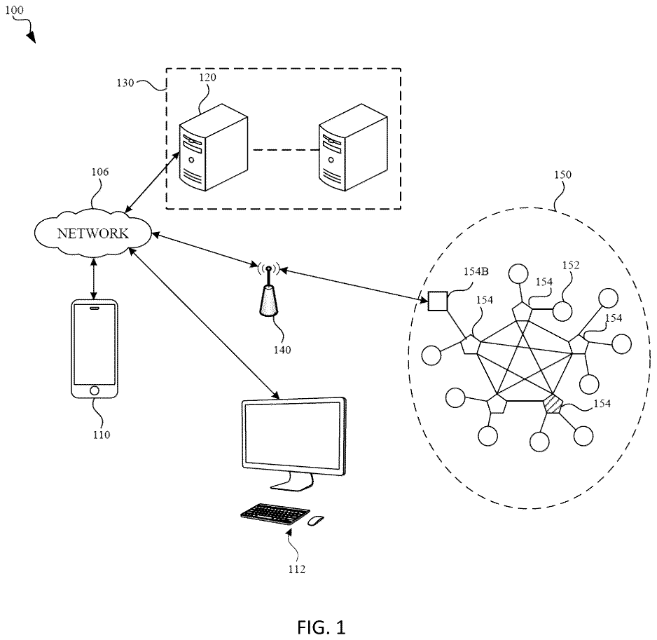

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100, which may operate in conjunction with the IEEE 802.15.4 standards for low-rate wireless personal area networks (LR-WPANs). It is understood that the concepts disclosed herein may also be applied to other networks, including Thread®, Zigbee®, Z-Wave®, Bluetooth Low Energy (BLE), ISA100.11a, WirelessHART®, MiWi™, IPv6 over Low-Power Wireless Personal Area Networks (6LoWPAN), Subnetwork Access Protocol (SNAP), Wi-Fi mesh networks, and the like.

In the example of FIG. 1, the network environment 100 includes an electronic device 110, an electronic device 112, a server 120, an access point 140 and a mesh network 150. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

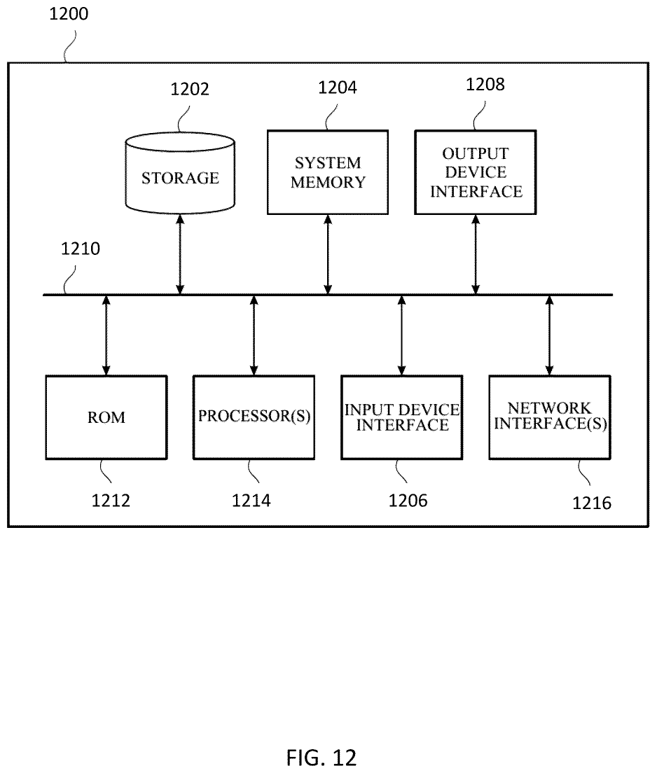

The electronic device 110 may be, for example, a desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 110 is depicted as a portable electronic device (e.g., a smartphone). The electronic device 110 may be, and/or may include all or part of, the electronic system discussed below with respect to FIG. 12.

The electronic device 112 may be, for example, desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 112 is depicted as a desktop computer. The electronic device 112 may be, and/or may include all or part of, the electronic system discussed below with respect to FIG. 12.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

In the example of FIG. 1, the electronic device 110 is depicted as a smartphone. However, it is appreciated that the electronic device 110 may be implemented as another type of device, such as a wearable device (e.g., a smart watch, smart ring, or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users. Although the electronic device 110 and the electronic device 112 are depicted as being outside the mesh network 150, in various use cases, and/or at various times, the electronic device 110 and/or the electronic device 112 may be included in the mesh network 150.

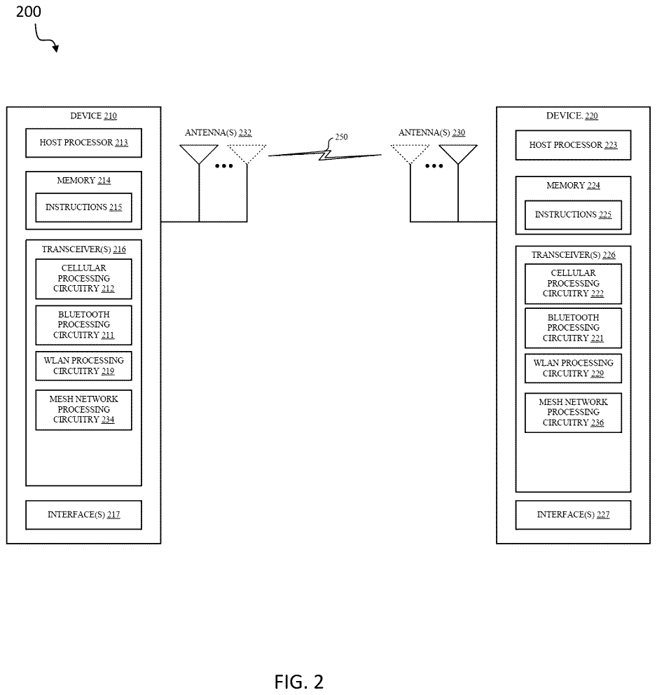

In the example of FIG. 1, the mesh network 150 includes various end devices 152 and routers 154 (each of which may include any one of the electronic devices 110 or 112, and/or other electronic devices). In one or more implementations, the routers 154 (represented as pentagons in the figure) may forward packets (e.g., data) between and/or to the end devices 152 (represented as circles in the figure) of the mesh network 150. In some use cases, a router 154 may transmit a packet via a radio or transceiver, such as the transceiver 226 of FIG. 2, to a targeted end device 152 via another router 154. The routers 154 may also provide secure commissioning services for other devices attempting to join the mesh network 150. The transceiver 226 of each router 154 may be enabled at times for a specified duration to receive

### And Transmit Packets.

In one or more implementations, the end devices 152 and the routers 154 may communicate according to a mesh network communication protocol (e.g., a Thread® network protocol or a Zigbee network protocol) for the mesh network 150. For example, the mesh network communication protocol may govern how a device acting as a router 154 forwards packets between end devices 152 of the mesh network 150. In one or more implementations, each device acting as a router 154 may act as a parent device for one or more of the end devices 152. The parent device may provide connectivity for, and manage communication with, the end devices that are child devices of that parent device. As such, an end device 152 may utilize a radio thereof to transmit a message to another end device 152, e.g., over the mesh network 150, via at least its parent router 154. As another example, the mesh network communication protocol may govern a modulation scheme for modulating a carrier signal to transmit information. As shown in FIG. 1, a mesh network, such as mesh network 150, may include multiple devices acting as routers 154. Devices that may act as routers 154 in the mesh network 150 may include devices that are specifically implemented (e.g., in hardware) as routers, and/or router-eligible end devices that can act as end devices and can perform router operations for other end devices.

Each end device 152 of the mesh network 150 may communicate primarily with a single router 154, which may be referred to as a parent (or parent device) of that end device 152. For example, the end devices 152 may not forward packets for other network devices (e.g., end devices 152 and router 154).

As discussed herein, in various implementations and/or use cases, the roles of various devices in the mesh network 150 may be dynamic. For example, if a router 154 does not have any child devices (e.g., communicatively coupled end devices 152), the router 154 may be downgraded and/or configured to operate as an end device 152. In another example, if a new end device attempting to join the mesh network 150 is within range of a current end device 152 of the mesh network 150 (but not a router 154), and that end device 152 is eligible to become a router 154 (e.g., is a router-eligible end device), that end device 152 may be upgraded and/or configured to operate as a router 154 for the new end device 152. In that case, the new router 154 acts as a router 154 with respect to the new end device and may be communicatively coupled to one or more other routers 154 of the mesh network 150.

Examples of devices that can operate as end devices 152 include a cellular phone, a smartphone (e.g., the electronic device 110), a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device. Some or all of the end devices 152 may be referred to as Internet-of-Things (IoT) devices. Some or all of the end devices 152 may have the capability of acting as a router 154, some of the end devices 152 may not have the capability of acting as routers, and/or some of the routers 154 may be specifically implemented (e.g., in hardware) as routers and may not have the capability of acting as an end device. As examples, the routers 154 may be implemented as routers or router-enable end devices (REEDs) that can act as routers or end devices. Examples of REEDs include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device with the capability (e.g., hardware and software capabilities) of acting as a router (e.g., forwarding packets for other devices).

In one or more implementations, a router 154 of the mesh network 150 may forward information between the mesh network and a non-mesh network, such as a Wi-Fi network. For example, the border router 154B may forward information between the mesh network 150 and a non-mesh network, such as the network 106, such as through the access point 140. In that case, the router may be referred to as a border router 154B, and may convert a Wi-Fi message to the mesh network communication protocol and transmit the converted mesh network message to a target end device 152 for the message using a mesh network radio. For explanatory purposes, only the border router 154B is illustrated as being connected to the access point 140, however, it is appreciated that the mesh network 150 may include more than one border router (e.g., one or more of the other routers 154 may also be configured to act as a border router 154B) connected to the access point 140 in some implementations.

FIG. 2 illustrates a block diagram of an example of a system including devices that may communicate wirelessly with each other in accordance with one or more implementations. The system 200 may be a portion of the network environment 100. The device 210 may be, for example, the electronic device 110 and/or one of the end devices 152 of the mesh network 150. The device 220 may be, for example, another portable device, another of the end devices 152 of the mesh network 150, and/or one of the routers 154 of the mesh network 150.

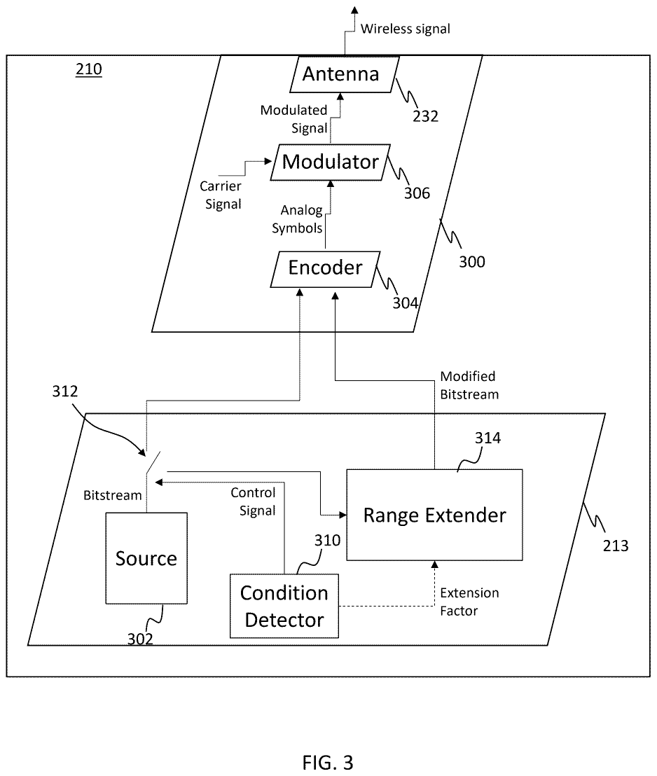

As shown in FIG. 2, the device 210 may include a host processor 213. The host processor 213 may execute instructions such that various operations of the device 210 are performed. For example, the host processor 213 can serve as the CPU responsible for executing instructions and managing various tasks, such as operations described herein in connection with FIGS. 3-11. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The device 210 may include wireless communication circuitry, such as one or more transceiver(s) 216 that may include radio frequency (RF) transmitter and/or receiver circuitry that use the antenna(s) 232 of the device 210 to facilitate signaling (e.g., transmitting and/or receiving of wireless signals 250) to and/or from other devices (e.g., the device 220) according to corresponding wireless communication protocols (e.g., Thread, Zigbee, cellular, Wi-Fi, Bluetooth, and/or other protocols). The one or more transceivers 216 can be responsible for both transmitting and receiving radio signals. The one or more transceivers 216 can facilitate wireless communication by converting digital data (e.g., in the form of bitstreams) into electromagnetic waves for transmission and then converting received electromagnetic waves back into digital data for the device 210 to process. The one or more transceivers 216 can operate within specific frequency bands allocated for wireless communication and may employ various modulation techniques to optimize data transmission efficiency and reliability. In one or more implementations, the one or more transceiver(s) 216 are not limited to specific wireless communication protocols, including Bluetooth, Thread®, Zigbee, Wi-Fi, cellular, among others, as it is appreciated that other wireless communication protocols and/or technologies can be associated with the one or more transceiver(s) 216.

The device 210 may include memory 214. The memory 214 may include a non-transitory computer-readable storage medium that stores instructions 215 (which may include, for example, the instructions being executed by one or more components in the transceiver 216 and/or the host processor 213). The instructions 215 may also be referred to as program code or a computer program. The memory 224 may also store data used by, and results computed by, the transceiver 216 and/or the host processor 213.

The device 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the RF components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the device 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The device 210 may include Bluetooth processing circuitry 211. The Bluetooth processing circuitry 211 is responsible for managing the transmission and reception of wireless signals to and from mobile devices (e.g., device 210) for Bluetooth communication. The Bluetooth processing circuitry 211 can perform various signal processing tasks related to modulation, demodulation, encoding, decoding, and error correction to ensure reliable communication over the air interface. The Bluetooth processing circuitry 211 may execute instructions such that various operations of the device 210 are performed, as described herein. The Bluetooth processing circuitry 211 may include one or more baseband processors implemented using, for example, a CPU, a DSP, an ASIC, a controller, an FPGA device, another hardware device, a firmware device, or any combination thereof configured to perform the operations described herein.

The device 210 may include WLAN processing circuitry 219. The WLAN processing circuitry 219 is responsible for managing the transmission and reception of wireless signals to and from mobile devices (e.g., device 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the device 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein. In one or more implementations, two or more of the processing circuitries of the transceivers 216 may be overlapping (e.g., provided by a combination chip or other common circuitry).

The device 210 may include mesh network processing circuitry 234. The mesh network processing circuitry 234 is responsible for managing the transmission and reception of wireless signals to and from mobile devices (e.g., device 210) for mesh network communication. The mesh network processing circuitry 234 can perform various signal processing tasks related to modulation, demodulation, encoding, decoding, and/or error correction to ensure reliable communication over the air interface. The mesh network processing circuitry 234 may include one or more baseband processors implemented using, for example, a CPU, a DSP, an ASIC, a controller, an FPGA device, another hardware device, a firmware device, or any combination thereof configured to perform the operations described herein.

In one or more implementations, the mesh network processing circuitry 234 may facilitate mesh network communication. The mesh network processing circuitry 234 may be responsible for converting digital data (e.g., bitstreams) from the host processor 213 into wireless signals for transmission over the air and/or for receiving incoming wireless signals, which are then converted into digital data for processing by the host processor 213. This collaboration enables the device 210 to transmit and receive data, supporting functions such as voice calls, text messaging, Internet access, and other wireless services via the mesh network 150 of FIG. 1. The host processor 213 may manage the digital signal processing tasks, while the mesh network processing circuitry 234 handles analog RF operations, working together to enable wireless communication capabilities in the device 210.

The device 210 may include one or more antenna(s) 232 (e.g., one, two, four, or more). In implementations having multiple antenna(s) 232, the device 220 may perform multiple-in-multiple-out (MIMO), digital beamforming, analog beamforming, beam steering, etc. For implementations with multiple antenna(s) 232, the device 210 may leverage the spatial diversity of such multiple antenna(s) 232 to send and/or receive multiple different data streams on the same time and frequency resources.

The device 210 may include one or more interface(s) 217. The interface(s) 217 may be used to provide input to or output from the device 210. For example, a device 210 that is a UE may include interface(s) 217 such as microphones, speakers, a touchscreen, buttons, and the like to allow for input and/or output to the UE by a user of the UE. Other interfaces of such a UE may be made up of transmitters, receivers, and other circuitry (e.g., other than the transceiver(s) 216/antenna(s) 232 already described) that allow for communication between the UE and other devices and may operate according to known protocols (e.g., Wi-Fi®, Bluetooth®, and the like).

The device 220 may include a host processor 223. The host processor 223 may execute instructions such that various operations of the device 220 are performed. For example, the host processor 223 can serve as the central processing unit (CPU) responsible for executing instructions and managing various tasks, such as one or more of the operations described herein in connection with FIGS. 3-11. The host processor 223 can include multiple cores, each capable of handling multiple threads simultaneously, enabling multitasking. The host processor 223 can integrate various components such as ALUs, registers, cache memory, and control units to execute instructions and process data. Additionally, the host processor 223 can include integrated DSPs, GPUs, NPUs, and hardware accelerators. The host processor 223 may be implemented using, for example, an ASIC, a controller, a FPGA device, another hardware device, a firmware device, or any combination thereof configured to perform the operations described herein.

The device 220 may include wireless communication circuitry, such as one or more transceiver(s) 226 that may include RF transmitter and/or receiver circuitry that use antenna(s) 230 of the device 220 to facilitate wireless signaling (e.g., exchanging of wireless signals 250) with other devices (e.g., the device 210) according to corresponding wireless communication protocols (e.g., cellular, Wi-Fi, Bluetooth). The one or more transceivers 226 can be responsible for both transmitting and receiving radio signals. The one or more transceivers 226 can facilitate wireless communication by converting digital data into electromagnetic waves for transmission and converting received electromagnetic waves into digital data for the device 220 to process. The one or more transceivers 226 can operate within specific frequency bands allocated for wireless communication and may employ various modulation techniques to optimize data transmission efficiency and reliability. In one or more implementations, the one or more transceiver(s) 226 are not limited to specific wireless communication protocols, including Bluetooth, Thread®, Wi-Fi, cellular, among others, as it is appreciated that other wireless communication protocols and/or technologies can be associated with the one or more transceiver(s) 226.

The device 220 may include memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the transceiver 226 and/or the host processor 223.

The device 220 may include cellular processing circuitry 222. The cellular processing circuitry 222 is responsible for managing the transmission and reception of wireless signals to and from mobile devices (e.g., device 210). The cellular processing circuitry 222 can perform various signal processing tasks related to modulation, demodulation, encoding, decoding, and error correction to ensure reliable communication over the air interface. The cellular processing circuitry 222 may execute instructions such that various operations of the device 220 are performed, as described herein. The cellular processing circuitry 222 may include one or more baseband processors implemented using, for example, a CPU, a DSP, an ASIC, a controller, an FPGA device, another hardware device, a firmware device, or any combination thereof configured to perform the operations described herein.

The device 220 may include Bluetooth processing circuitry 221. The Bluetooth processing circuitry 221 is responsible for managing the transmission and reception of wireless signals to and from mobile devices (e.g., device 210) for Bluetooth communication. The Bluetooth processing circuitry 221 can perform various signal processing tasks related to modulation, demodulation, encoding, decoding, and error correction to ensure reliable communication over the air interface. The Bluetooth processing circuitry 221 may execute instructions such that various operations of the device 220 are performed, as described herein. The Bluetooth processing circuitry 221 may include one or more processors implemented using, for example, a CPU, a DSP, an ASIC, a controller, an FPGA device, another hardware device, a firmware device, or any combination thereof configured to perform the operations described herein.

The device 220 may include WLAN processing circuitry 229. The WLAN processing circuitry 229 is responsible for managing the transmission and reception of wireless signals to and from mobile devices (e.g., device 210) for Wi-Fi communication. The WLAN processing circuitry 229 can perform various signal processing tasks related to modulation, demodulation, encoding, decoding, and error correction to ensure reliable communication over the air interface. The WLAN processing circuitry 229 may execute instructions such that various operations of the device 220 are performed, as described herein. The WLAN processing circuitry 229 may include one or more processors implemented using, for example, a CPU, a DSP, an ASIC, a controller, an FPGA device, another hardware device, a firmware device, or any combination thereof configured to perform the operations described herein. In one or more implementations, two or more of the processing circuitries of the transceivers 226 may be overlapping (e.g., provided by a combination chip or other common circuitry).

The device 220 may include mesh network processing circuitry 236. The mesh network processing circuitry 236 may be responsible for managing the transmission and reception of wireless signals to and from mobile devices (e.g., device 210) for mesh network communication. The mesh network processing circuitry 236 can perform various signal processing tasks related to modulation, demodulation, encoding, decoding, and/or error correction to ensure reliable communication over the air interface. The mesh network processing circuitry 236 may include one or more processors implemented using, for example, a CPU, a DSP, an ASIC, a controller, an FPGA device, another hardware device, a firmware device, or any combination thereof configured to perform the operations described herein.

The mesh network processing circuitry 236 may be responsible for converting digital data from the host processor 223 into electromagnetic signals for transmission over the air and for receiving incoming electromagnetic signals, which are converted into digital data for processing by the host processor 223. This collaboration enables the device 220 to transmit and receive data, supporting functions such as audio services, Internet access, and other wireless services via the mesh network 150 of FIG. 1. The host processor 213 may manage the digital signal processing tasks, and the mesh network processing circuitry 236 may handle analog RF operations, working together to enable wireless communication capabilities in the device 220.

The device 220 may include one or more antenna(s) 230 (e.g., one, two, four, or more). In implementations having multiple antenna(s) 230, the device 220 may perform multiple-in-multiple-out (MIMO), digital beamforming, analog beamforming, beam steering, etc.

The device 220 may include one or more interface(s) 227. The interface(s) 227 may be used to provide input to or output from the device 220. For example, a device 220 may include interface(s) 227 made up of transmitters, receivers, and other circuitry (e.g., other than the transceiver(s) 226/antenna(s) 230 already described) that enables the device 220 to communicate with other equipment in the mesh network 150, and/or that enables the device 220 to communicate with external networks, computers, databases, and the like for purposes of operations, administration, and maintenance of the device 220 or other equipment operably connected thereto.

In one or more implementations, multiple wireless communication protocols (e.g., mesh network and Bluetooth technologies) may coexist in an electronic device (e.g., electronic devices 110-112 of FIG. 1) with a shared radio that operates at 2.4 gigahertz for both Bluetooth and mesh network technologies. The integrated circuit (IC) chip responsible for modulation and demodulation, the software stack, the hardware stack, and the antennas for transmission and reception may include shared resources between the Bluetooth and mesh network technologies. In one or more implementations, when the mesh network processing circuitry 234 is active, the Bluetooth processing circuitry 211 may not be active, and vice versa, resulting in time division multiplexing between the Bluetooth and mesh network technologies.

In one or more implementations, the device 210 and/or the device 220 may perform range extension operations to extend the range of physical distances over which the device 210 and the device 220 can communicate using the wireless signals 250. In some examples described herein, device 210 is described as a sending device or transmitting device, and device 220 is described as a receiving device. However, in other use cases, the device 220 may operate as a sending device or transmitting device, and device 210 may perform the receiving device operations described herein.

For example, FIG. 3 is a block diagram of the device 210, illustrating various sending device operations that may be performed for range extension for the device 210. Various portions of the architecture of FIG. 3 can be implemented in software, firmware, and/or hardware, including by one or more processors and a memory device containing instructions, which when executed by the processor cause the processor to perform the operations described herein. For example, in FIG. 3, the trapezoidal boxes may indicate that the host processor 213, wireless communication circuitry 300, an encoder 304, a modulator 306, and the antenna(s) 232 may be hardware components, and the rectangular boxes may indicate that a source 302, a condition detector 310, and a range extender 314 may be implemented in software, including by execution of instructions by one or more processors and a memory device containing the instructions, which when executed by the processor cause the processor to perform the operations described herein.

In the example of FIG. 3, the device 210 includes the host processor 213 and wireless communication circuitry 300. For example, the wireless communication circuitry 300 may be an implementation of the transceivers 216 and/or the antenna(s) 232 of FIG. 2 (e.g., including the mesh network processing circuitry 234). As shown, a source 302 (e.g., an application, a system process, or other data generating process at the device 210, such as running on the host processor 213) may generate data for wireless transmission. For example, the data may be generated in the form of a bitstream (e.g., a sequence of bits having values of zero or one, the particular pattern of zeros and ones encoding the data to be transmitted).

As shown in FIG. 3, either the bitstream from the source 302, or a modified bitstream, may be provided to the wireless communication circuitry 300 for transmission. In this example, a condition detector 310 may determine whether a range extension condition exists at the device 210. A range extension condition may include a low signal strength condition (e.g., in which wireless signals received from one or more other devices have a Received Signal Strength Indicator (RSSI) less than a threshold RSSI), a high error rate condition (e.g., in which the percentage of received packets or frames that include errors is higher than a threshold percentage), and/or an emergency condition. For example, an emergency condition may include an “SOS” condition, in which the device 210 is transmitting a help or SOS signal. The emergency condition may be triggered by a user input (e.g., to the interface(s) 217) activating the emergency condition, or based on sensor data indicating a fall, an impact, a lack of motion, or a prone position of a user of the device 210.

As shown, the condition detector 310 may generate a control signal based on whether a range extension condition has been detected. For example, the control signal may operate a switch 312 (e.g., a digital switch or software switch) that provides the bitstream from the source 302 to the wireless communication circuitry 300 if no range extension condition is detected, and that causes the bitstream from the source 302 to be provided to a range extender 314 if a range extension condition is detected.

As shown, the range extender 314 may modify (e.g., digitally modify) the bitstream, before the bitstream is provided to the wireless communication circuitry 300, to generate a modified bitstream that is provided to the wireless communication circuitry 300 (e.g., in place of the bitstream from the source 302). As discussed in further detail hereinafter, the modified bitstream may cause the wireless communication circuitry 300 to reduce a symbol space into which the data from the source 302 is encoded for transmission (e.g., without modifying the wireless communication circuitry 300). For example, the wireless communication circuitry 300 (e.g., an encoder 304 of the wireless communication circuitry) may perform the same encoding operation, whether the bitstream or the modified bitstream is received. However, the digital change in the modified bitstream may prevent the wireless communication circuitry 300 from generating some of the symbols it is capable of generating.

As shown, in one or more implementations, the condition detector 310 may also provide an extension factor to the range extender 314. The range extender 314 may modify the bitstream differently based on different extension factors received from the condition detector 310. For example, the extension factor may indicate a number of duplicate bits to be included in the modified bitstream for (e.g., and adjacent to) each bit in the bitstream. As examples, an extension factor of two may indicate that each bit in the bitstream should be duplicated once (to double the number of bits in the bitstream), or an extension factor of four may indicate that each bit in the bitstream should be duplicated three times (to quadruple the number of bits in the bitstream). Expanding the bitstream to form the modified bitstream in this way reduces the rate at which data can be transmitted by the device 210, but extends the range within which the data that is transmitted can be detected and accurately received at another device (e.g., the device 220), such as by reducing the number of distinct symbols to be recognized by the other device.

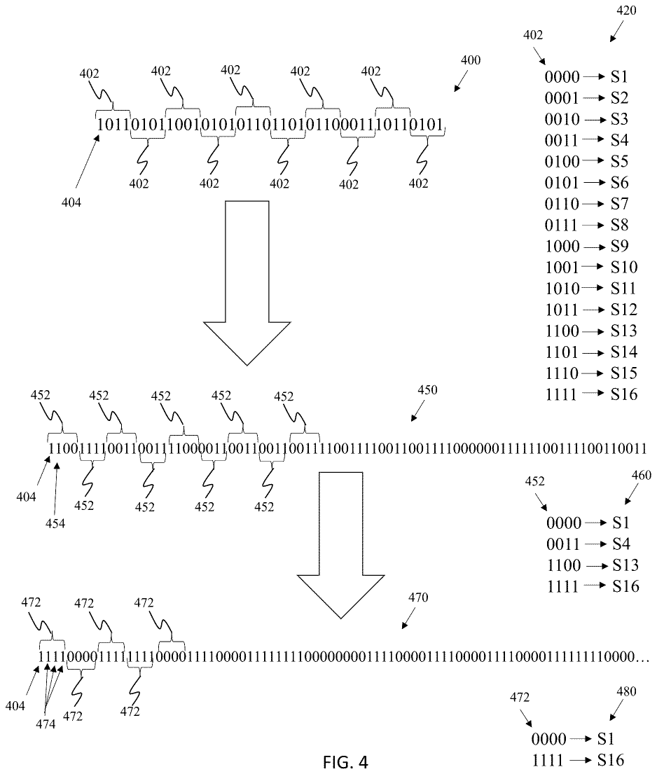

FIG. 4 illustrates an example of a bitstream that can be modified (e.g., expanded) by the host processor 213 (e.g., by the range extender 314), prior to the bitstream being provided to the wireless communication circuitry 300 for (e.g., encoding, modulation, and) transmission. As shown in FIG. 4, a bitstream 400 may include a sequence of bits 404. For example, the bits 404 may be generated in a stream by a data source, such as source 302 of FIG. 3.

In one or more implementations, the wireless communication circuitry 300 of FIG. 3 may be arranged (e.g., physically configured and programmed) to perform an encoding operation that maps a bitstream, such as the bitstream 400, into a symbol space 420 that includes a first number of symbols (e.g., S1-S16 in the figure). In the example of FIG. 4, the symbol space 420 includes sixteen unique symbols. For example, the sixteen unique symbols may correspond to sixteen unique phases, amplitudes, frequencies, and/or spreading codes that the wireless communication circuitry 300 is capable of applying to a carrier signal to modulate that carrier signal for wireless transmission of information. FIG. 4 illustrates how distinct groups 402 of a first number of bits (e.g., four bits) may be mapped to distinct symbols of the symbol space 420. The mapping of the groups 402 of four bits to symbol labels S1-S16 in FIG. 4 is merely illustrative, and other mappings and/or other symbol labels can be used.

In one or more implementations, the bitstream 400 may be modified (e.g., expanded), to generate a modified bitstream 450. For example, the bitstream 400 may be modified responsive to identification of a range extension condition for wireless communications from the device 210. FIG. 4 illustrates one example of how the bitstream may be modified. As shown in the example of FIG. 4, the modified bitstream 450 may include (e.g., adjacent to each bit 404 in the bitstream 400) a duplicate (e.g., duplicate bit 454) of each bit 404 in the bitstream 400. For example, the modified bitstream 450 may be generated based on an expansion factor of two (e.g., so that there are two adjacent copies of each bit in the bitstream 400 in the modified bitstream 470). As illustrated in FIG. 4, modifying the bitstream by duplicating the bits 404 in this way may cause each set 452 of the bits 404 (having the same number of bits (e.g., four) as the groups 402) to map, according to the same encoding operation of the wireless communications circuitry 300 that maps the bitstream 400 into the full symbol space 420, to a reduced symbol space 460. In this example, the reduced symbol space 460 includes a subset (e.g., S1, S4, S13, and S16) of (e.g., four of) the symbols from the symbol space 420. However, it is appreciated that the subset of the symbols in the reduced symbol space 460 in FIG. 4 is merely illustrative, and other modifications can be made to the bitstream 400 to map the sets 452 of the bits 404 to a reduced symbol space 460 that includes a different a subset (e.g., S4, S8, S12, and S16) of (e.g., four of) the symbols from the symbol space 420.

In one or more implementations, the bitstream 400 may be further modified (e.g., expanded) as is also shown in FIG. 4, to generate a modified bitstream 470. As shown, the modified bitstream 470 may include (e.g., adjacent to each bit 404 in the bitstream 400) multiple (e.g. three) duplicates (e.g., duplicate bits 474) of each bit 404 in the bitstream 400. For example, the modified bitstream 470 may be generated based on an expansion factor of four (e.g., so that there are four adjacent copies of each bit in the bitstream 400 in the modified bitstream 470). As illustrated in FIG. 4, modifying the bitstream by including multiple duplicates of the bits 404 in this way may cause each set 472 of the bits 404 (having the same number of bits (e.g., four) as the groups 402) to map, according to the same encoding operation of the wireless communications circuitry 300 that maps the bitstream 400 into the full symbol space 420, to a reduced symbol space 480. In this example, the reduced symbol space 480 includes a subset (e.g., S1 and S16) of (e.g., two of) the symbols from the symbol space 420. In other examples, the bitstream 400 can be modified to cause the reduced symbol space 480 to include a different subset of two of the symbols from the symbol space 420.

Returning to FIG. 3, whether the bitstream 400 or a modified bitstream (e.g., modified bitstream 450 or modified bitstream 470) is received by the wireless communication circuitry 300, the encoder 304 may encode the bitstream or the modified bitstream (e.g., using the same encoding operation) to generate corresponding analog symbols (e.g., analog versions of the symbols S1, etc. of FIG. 4). The analog symbols generated by the encoder 304 using the modified bitstream may be reduced compared to the analog symbols that would be generated using the unmodified bitstream), as discussed in connection with FIG. 4. A modulator 306 may then modulate a carrier signal using the analog signals to generate a modulated signal that is transmitted by the antenna(s) 232 as a wireless signal.

In this way, modifying the bitstream 400 to the modified bitstream 450 or the modified bitstream 470 may extend the range of wireless communications from the device 210. For example, the modified bitstream 450 or the modified bitstream 470 may be more resilient to errors that typically occur when transmitting over an extended range (e.g., because a receiving device may more easily distinguish between the four symbols of the reduced symbol space 460, or between the two symbols of the reduced symbol space 480, than between the sixteen symbols of the symbol space 420, when the symbols are represented in the modulated wireless signal). The modified bitstream 470 may extend the range further than the modified bitstream 450, at a cost of a lower data transmission rate.

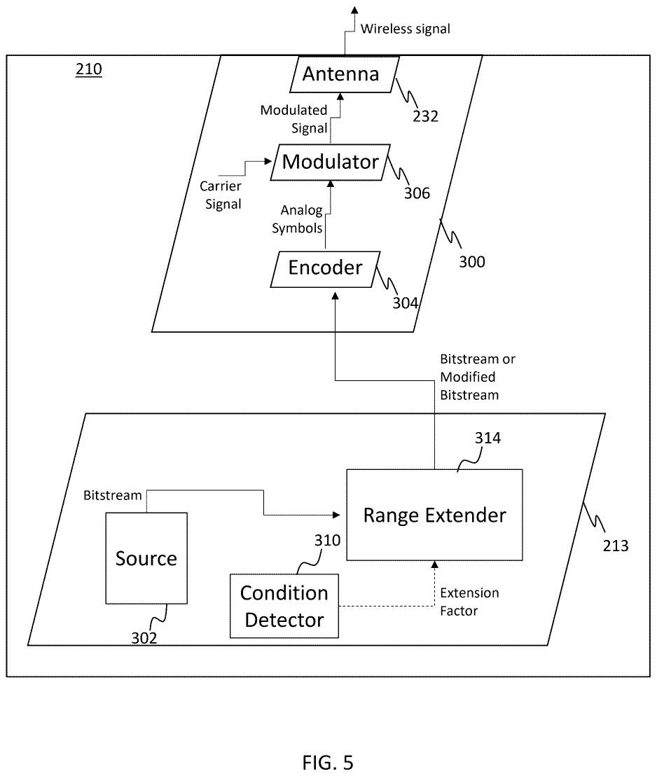

The example of FIG. 3, in which a switch 312 is operated by the condition detector to control whether the bitstream is provided to the wireless communication circuitry 300 or to the range extender 314 is merely illustrative. FIG. 5 illustrates another example implementation in which the bitstream from the source 302 is always provided to the range extender 314, and the range extender 314 can output either the bitstream (e.g., unmodified, if the extension factor is one) or a modified bitstream (e.g., if the extension factor is different from one, such as two or four).

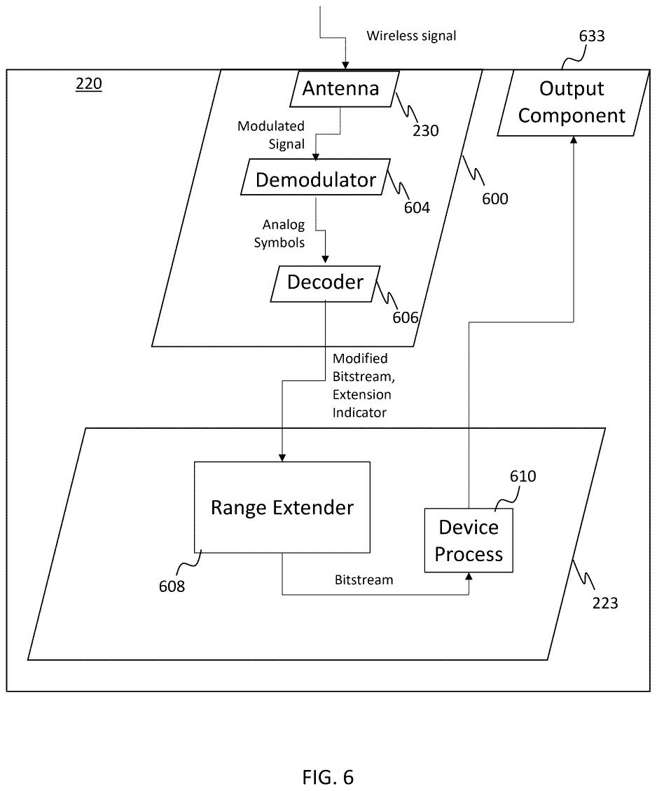

FIG. 6 illustrates how a receiving device, such as the device 220, that receives the wireless signal transmitted by the device 210 based on a modified bitstream (e.g., the modified bitstream 450 or the modified bitstream 470) for range extension, may perform one or more additional operations to extract the original bitstream from the wireless signal. As shown, the device 220 may receive a wireless signal (e.g., from the device 210) using wireless communication circuitry 600. For example, the device 220 may include the host processor 223 of FIG. 2, and the wireless communication circuitry 600 may be an implementation of the transceivers 226 and/or the antenna(s) 230 of FIG. 2 (e.g., including the mesh network processing circuitry 236).

As shown, a modulated signal may be provided form the antenna(s) 230 to a demodulator 604 of the wireless communication circuitry 600. The demodulator 604 may demodulate the modulated signal to identify one or more symbols. Because the modulated signal was generated (e.g., at the device 210) using a modified bitstream (e.g., the modified bitstream 450 or the modified bitstream 470), the identified symbols may be symbols that are in a first subset (e.g., the reduced symbol space 460 or the reduced symbol space 480) of a set of symbols (e.g., the symbols of the symbol space 420) that the wireless communication circuitry 600 is capable of identifying. For example, the first subset may include less than all the set of symbols (e.g., as described herein in connection with FIG. 4).

As illustrated in FIG. 6, the demodulator 604 may provide the identified symbols (e.g., analog symbols) to a decoder 606. The decoder 606 may map the identified symbols into corresponding sets of bits (e.g., sets 452 or sets 472). The sets of bits may be provided from the wireless communication circuitry 600 to the host processor 223. The sets of bits may correspond to the modified bitstream (e.g., the modified bitstream 450 or the modified bitstream 470) that was used at the sending device to generate the wireless signal received by the device 220.

As shown, the decoder 606 may also provide an extension indicator (e.g., received in the wireless signal) to the host processor 223. The extension indicator may indicate to the host processor 223 whether the bitstream received from the decoder 606 is a modified or original bitstream. If the extension indicator indicates that the bitstream received from the decoder 606 is a modified bitstream, the host processor 223 (e.g., a range extender 608 running on the host processor) may reduce the bitstream received from the decoder 606 to generate a reduced bitstream having at least one bit group (e.g., one of the groups 402 of FIG. 4) corresponding to a symbol of a second subset, distinct from the first subset of the set of symbols. For example, the second subset may include the groups 402 corresponding to the remaining symbols of the symbol space 420 that are not included in the reduced symbol space 460 (e.g., if the extension indicator indicates an extension factor of two) or that are not included in the reduced symbol space 480 (e.g., if the extension indicator indicates an extension factor of four). For example, referring to the exemplary implementation of FIG. 4, in which the first subset of the symbols includes symbols S1, S4, S13, and S16, the second subset may include symbols S2, S3, S5-S12, S14, and S15 if the extension indicator indicates an extension factor of two (e.g., indicating that the number of bits in the original bitstream was doubled). In another exemplary implementation in which the extension indicator indicates an extension factor of two, the first subset of the symbol may include symbols S4, S8, S12, and S16, and the second subset may include symbols S1-S3, S5-S7, S9-S11, and S13-S15. As another example in which the first subset includes the symbols S1 and S16, the second subset may include symbols S2-S15 of FIG. 4 if the extension indicator indicates an extension factor of four (e.g., indicating that the number of bits in the original bitstream was quadrupled). The range extender 608 may recover the original bitstream 400 (e.g., a reduced bitstream relative to the modified bitstream) from a modified bitstream by removing duplicate bits (e.g., duplicate bits 454 or 474, according to the extension factor) from the modified bitstream).

Once the range extender 608 has recovered the original bitstream 400, the original bitstream may be provided to one or more device processes, such as the device process 610 (e.g., an application or a system process running on the host processor 223). The host processor 223 (e.g., the device process 610) may then operate the device 220 based, at least in part, on the original bitstream. For example, the device process 610 may operate an output component 633 (e.g., a display, a speaker, a haptic component, and/or other output component) based on the original bitstream (e.g., to generate and/or modify display content, audio content, and/or haptic content for output by the device 220). As another example, the device process 610 may operate the device 220 based on the original bitstream by operating the wireless communication circuitry 600 to transmit a response to the original bitstream. In one or more use cases, the response may include a modified bitstream, modified as discussed in connection with FIGS. 3 and 4 (but by the device 220), for an extended range of the communication of the response.

In one or more implementations, the device 220 may, at another time, receive (e.g., without an extension indicator, or with an extension indicator indicating an extension factor of one) another wireless communication generated based on an unmodified bitstream (e.g., bitstream 400) from another device, such as the device 210. The wireless communication circuitry 600 may demodulate the other wireless communication into the full set of symbols of the symbol space 420 of FIG. 4 using the same demodulation operation used to process the wireless communication that was generated based on the modified bitstream.

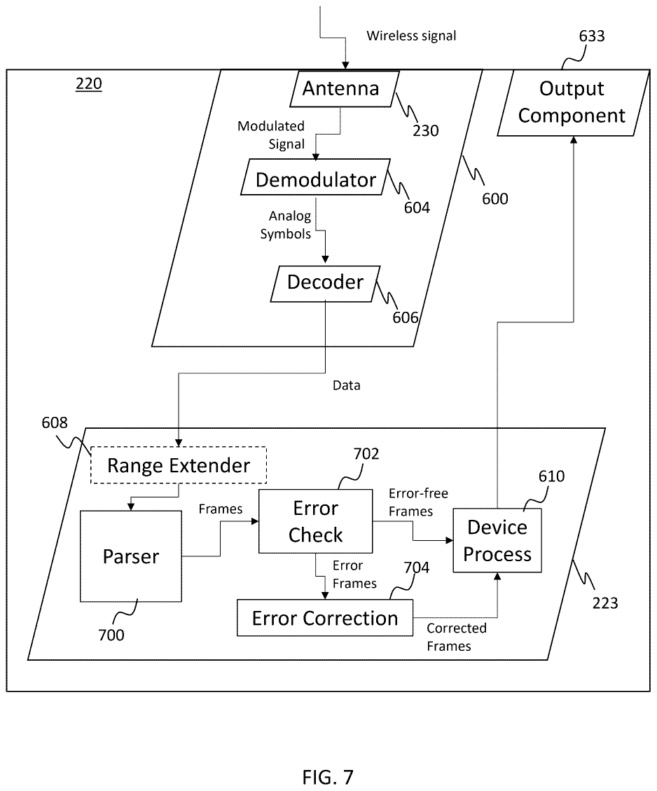

In one or more implementations, a receiving device, such as the device 220, that receives a wireless communication from another device (e.g., the device 210) may perform one or more range extending operations that are distinct from the reduction of the modified bitstream that is described in connection with FIG. 6. For example, FIG. 7 illustrates how the device 220 may provide data (e.g., a modified bitstream or an original bitstream) to a parser 700 running on the host processor 223. The parser 700 may parse the data into one or more frames of data. In one or more use cases, the frames may include errors. In one or more implementations, the frames may be provided to an error check operation 702 at the host processor 223. For example, the error check operation 702 may perform cyclic redundancy check (CRC) operation on the frames. For example, the CRC operation may include generating a CRC value from the bits in a frame, and comparing the generated CRC value to a reference value (e.g., a checksum value) received with the frame (e.g., in a Frame Check Sequence (FCS) at or near the end of the frame).

Typically, frames that fail a CRC check are discarded, and new versions of the frame are received until the CRC check is passed. However, this can be an inefficient use of bandwidth and can fail entirely if no frame is eventually received that passes the CRC check. This type of failure can occur when the sending/transmitting device at, near, or outside of a range of the wireless communication circuitry 600 of the device 220. In accordance with aspects of the subject technology, the device 220 can extend the range within which frames can be accurately received by performing an error correction operation 704 using frames that contain errors. For example, as shown in FIG. 7, if the error check operation 702 determines that a frame contains an error (e.g., fails the error check operation 702), the frame containing the error (e.g., an error frame) may be provided to an error check operation 702.

The error correction operation 704 may accumulate multiple versions of the error frame (e.g., received in multiple repeated attempts by a sending device to send the same frame, each resulting in an error in at least one of the bits of the frame). Because the errors in the error frames are likely to be approximately random, the error correction operation 704 may use the multiple versions of the error frames to determine a corrected frame (e.g., a frame that is identical to an original frame generated by the sending/transmitting device of the frame). This is because at least some (e.g., most) of the accumulated versions of the frame will likely have the correct bit value at a particular bit location in the frame (e.g., as compared with a smaller number of frames that have an error at that location). As shown, the corrected frame may be passed to one or more device processes, such as the device process 610 (e.g., for operation of the device 220 based on the corrected frame(s)).

FIG. 7 also shows how, if the error check operation 702 does not detect an error (e.g., if a frame is an error-free frame that passes the error check operation 702), the frame may be passed to one or more device processes, such as the device process 610 (e.g., for operation of the device 220 based on the received frame(s)).

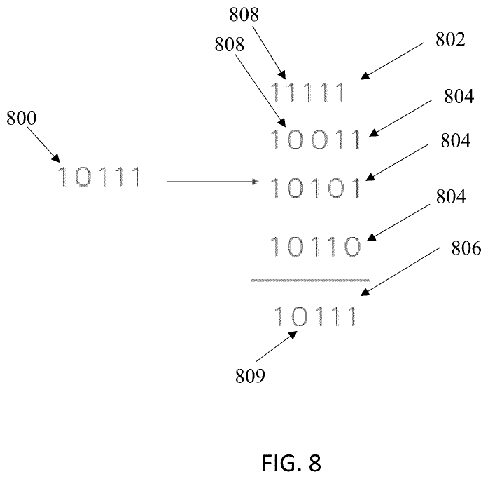

FIG. 8 illustrates an example of the error correction operation 704 that may be performed to generate a corrected frame. As shown in FIG. 8, an original frame 800 may include a particular string of bit values (e.g., 10111 in this example). As shown, a frame 802 may include an error (e.g., a “1” instead of a “0”) at a location 808 within the frame. Errors of this type can occur due to an incorrect extraction of the bit values (e.g., by the demodulator 604 or by the decoder 606) from the incoming wireless signal (e.g., due to a weak signal strength at or near an edge of a range of the wireless communication circuitry 600 of the device 220).

As shown, one or more additional versions 804 of the frame 800 (e.g., which may be accumulated by the error correction operation 704) may also include errors, but at different locations within the frame. In this example the additional versions 804 of the frame 800 include the correct bit 809 (e.g., zero) at the location 808 within the frame. Accordingly, the additional versions 804 of the frame 800 may be used by the error correction operation 704 to determine (e.g., using a maximum likelihood estimator or a trained machine learning model) to determine the correct bit value for each location within the frame. The correct bit values may then be assembled to form a corrected frame 806, which may then be provided to one or more device processes, such as the device process 610 (e.g., for operation of the device 220 based on the corrected frame(s)). As shown, the corrected frame 806 is identical to the original frame 800. The corrected frame 806 may be provided to the error check operation 702 to confirm the corrected frame 806 passes the error check operation 702 before providing the corrected frame 806 to the device process(es).

Returning to FIG. 7, a range extender 608 may also be provided along with the error correction operation 704 in some implementations. Range extender 608 may prevent the errors shown in FIG. 8 from occurring in some use cases, and/or the operations of FIGS. 7 and 8 may be performed in addition to the range extender 608 operations to further extend the range within which wireless communications can be accurately received and processed at the device 220.

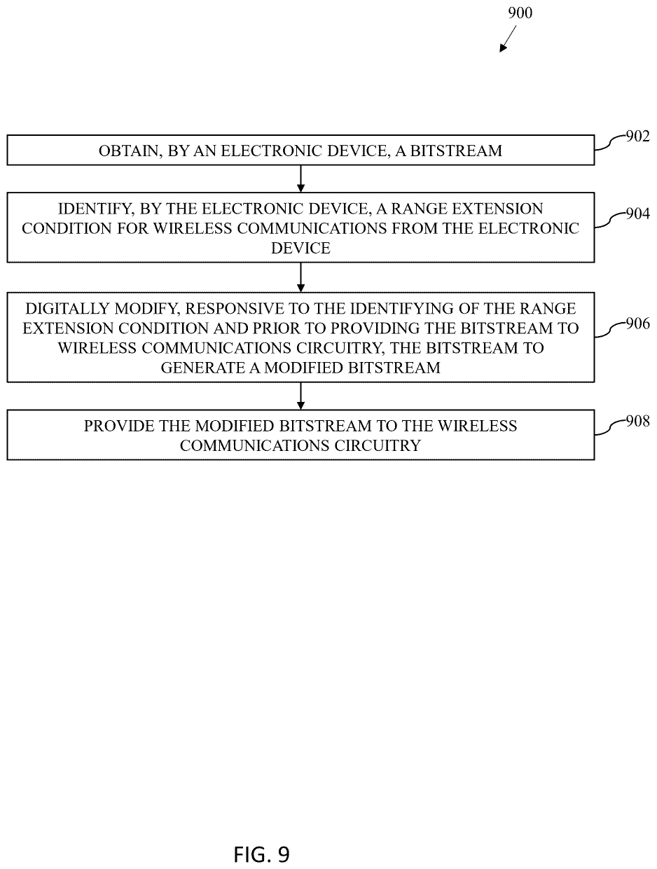

FIG. 9 is a flow chart of an example process 900 that may be performed for range extension in accordance with one or more implementations. For explanatory purposes, the process 900 is primarily described herein with reference to the device 210 of FIG. 2. However, the process 900 is not limited to the device 210 of FIG, and one or more blocks (or operations) of the process 900 may be performed by one or more other components of other suitable devices and/or servers. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

As illustrated in FIG. 9, at block 902, an electronic device (e.g., device 210), may obtain a bitstream (e.g., bitstream 400). The electronic device may include wireless communication circuitry (e.g., wireless communication circuitry 300) configured to perform an encoding operation to map the bitstream into a symbol space (e.g., symbol space 420) that includes a first number of symbols. For example, the first number of symbols may include sixteen symbols (e.g., S1-S16), and the second number of symbols may include four symbols (e.g., S1, S4, S13, and S16) or two symbols (e.g., S1 and S16, as discussed herein in connection with FIG. 4). In one or more implementations, the wireless communication circuitry may be capable of (e.g., physically programmed to) performing a first number of modulations (e.g., phase modulations, frequency modulations, and/or amplitude modulations, including, for example, Offset Quadrature Phase Shift Keying (O-QPSK) modulations or Quadrature amplitude modulations (QAM)), corresponding respectively to the first number of symbols, of a signal for wireless transmission.

At block 904, the electronic device may identify a range extension condition for wireless communications from the electronic device. As examples, the range extension condition may include a low signal strength (e.g., indicated by an RSSI below a threshold value) condition or a high error rate (e.g., indicated by an error rate over a threshold rate) condition. As another example, the range extension condition may include an emergency mode operating condition of the electronic device. For example, the emergency mode operating condition may be operating in an “SOS” mode, in which the electronic device transmits help-request messages to be received by other devices within a given extended range (e.g., an extended range of five hundred meters, in comparison to an un-extended range of between two hundred and two hundred fifty meters) of the electronic device. The SOS mode may be triggered by a user input to the device (e.g., to activate the SOS mode using a user interface component of the device) or based on a device-detected event (e.g., a fall, a cardiac event, a lack of user motion, or a prone position) associated with the user.

At block 906, the electronic device may digitally modify, responsive to identifying of the range extension condition and prior to providing the bitstream to the wireless communications circuitry, the bitstream to generate a modified bitstream (e.g., modified bitstream 450 or modified bitstream 470) that maps, according to the encoding operation of the wireless communications circuitry, to a reduced symbol space (e.g., reduced symbol space 460 or reduced symbol space 480) that includes a second number of symbols smaller than the first number of symbols. The wireless communication circuitry may be configured to encode, using the encoding operation, groups (e.g., groups 402) of a first number of bits (e.g., four bits) in the bitstream into respective ones of the first number of symbols, and modifying the bitstream may cause the wireless communication circuitry to encode sets (e.g., sets 452 or sets 472) of the first number of bits (e.g., four bits) in the modified bitstream into respective one of the second number of symbols, smaller than the first number of symbols, in the reduced symbol space. For example, modifying the bitstream may include inserting, into the bitstream adjacent to a bit in the bitstream (e.g., adjacent to each bit 404 in the bitstream), at least one duplicate (e.g., one duplicate bit 454 or three duplicate bits 474) of that bit in the bitstream.

At block 908, the electronic device may provide the modified bitstream to the wireless communications circuitry for encoding, using the encoding operation, of the modified bitstream into the reduced symbol space including the second number of symbols; and transmission of a wireless signal corresponding to the modified bitstream encoded into the reduced symbol space including the second number of symbols. In one or more implementations, the electronic device may also provide an indicator (e.g., a flag, such as one or more flag bits, such as an extension indicator and/or extension factor) of the second number of symbols to the wireless communication circuitry for transmission with (e.g., in a header of, such as in a physical layer header of) the wireless signal corresponding to the modified bitstream.

The wireless communications circuitry may (e.g., as discussed herein in connection with FIG. 4) encode (e.g., by encoder 304) the sets of the first number of bits in the modified bitstream into the respective ones of the second number of symbols smaller than the first number of symbols, perform (e.g., by encoder 304 or modulator 306) an analog conversion of the respective ones of the second number of symbols for the sets of the first number of bits to generate one or more analog signals; perform (e.g., by modulator 306) a phase modulation (e.g., an O-QPSK modulation and/or a QAM modulation) of the wireless signal using the one or more analog signals; and transmit (e.g., using antenna 232) the wireless signal (e.g., to another device, such as the device 220 of FIG. 2).

In one or more implementations, encoding, using the encoding operation, the modified bitstream into the reduced symbol space includes encoding the modified bitstream without modifying the encoding operation. In one or more implementations, the process 900 may also include identifying, by the electronic device (e.g., by the host processor 213), an end of the range extension condition (e.g., by detecting an increase in signal strength, a reduced error rate, or an end of an SOS mode, such as by a user input to the device). The process 900 may also include (e.g., responsive to identifying the end of the SOS mode) ceasing modifying the bitstream; providing the bitstream, without modification, to the wireless communication circuitry; and encoding, using the encoding operation, the bitstream into the symbol space (e.g., the symbol space 420) that includes the first number of symbols.

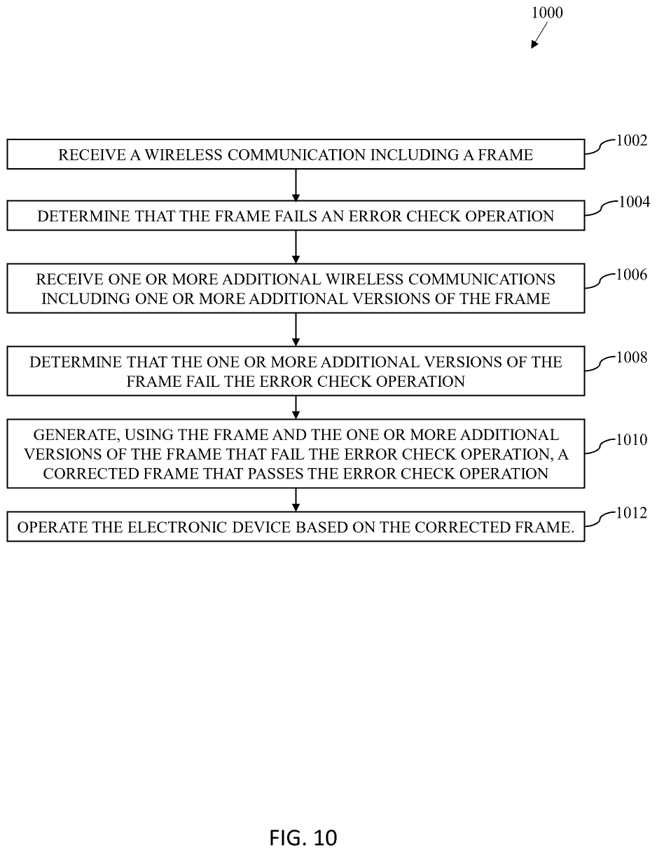

FIG. 10 is a flow chart of an example process 1000 that may be performed for range extension in accordance with one or more implementations. For explanatory purposes, the process 1000 is primarily described herein with reference to the device 220 of FIG. 2. However, the process 1000 is not limited to the device 220 of FIG, and one or more blocks (or operations) of the process 1000 may be performed by one or more other components of other suitable devices and/or servers. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, an electronic device (e.g., device 220) may receive (e.g., using wireless communication circuitry 600) a wireless communication that includes a frame (e.g., an erroneous frame 802).

At block 1004, the electronic device may determine that the frame fails an error check operation (e.g., error check operation 702). For example, the error check operation may include a cyclic redundancy check (CRC) operation.

At block 1006, the electronic device may receive one or more additional wireless communications including one or more additional versions (e.g., additional erroneous versions 804) of the frame.

At block 1008, the electronic device may determine that the one or more additional versions of the frame fail the error check operation. For example, as each of the one or more additional wireless communications is received, the electronic device may perform the CRC operation on the frame(s) in that communication. In one or more implementations, the electronic device may accumulate and store (e.g., temporarily) frames having errors (e.g., error frames that do not pass the CRC check).

At block 1010, the electronic device (e.g., error correction operation 704) may generate, using the frame and the one or more additional versions of the frame that fail the error check operation, a corrected frame (e.g., a corrected frame 806) that passes the error check operation. The corrected frame may be identical to an original frame (e.g., original frame 800) transmitted by a remote device (e.g., device 210). For example, the electronic device may use a maximum likelihood operation on the frame and the one or more additional versions of the frame to generate the corrected frame. For example, the frame and the one or more additional versions of the frame may each include at least one erroneous bit (e.g., an erroneous bit at a location 808) that that prevents a CRC value calculated by the electronic device from matching a CRC value received with the frame).

Generating the corrected frame may include determining a correct bit (e.g., correct bit 809) for the at least one erroneous bit in the frame or the one or more additional versions of the frame, using at least one of the frames or the one or more additional versions of the frame that includes the correct bit. For example, if many, most, or all of the one or more additional versions of the frame include a common value (e.g., zero) at a particular bit location, and the frame includes a different value (e.g., one) at that location, the electronic device may determine that the common value is the correct value for that bit location in the corrected frame. In one or more implementations, the frame and the one or more additional versions of the frame may include a number of frames that is equal to or greater than a total number of the erroneous bits in the frame and the one or more additional versions of the frame. In this way, the accumulated versions of the frame may be sufficient to correct all of the errors in the accumulated versions of the frames. Generating the corrected frame may extend a detection range of the electronic device for detecting and/or processing the wireless communication. For example, generating a corrected frame in this way may extend the range (e.g., the maximum physical distance to a transmitting device) with which the electronic device can receive accurate wirelessly transmitted information from another device.

At block 1012, the electronic device (e.g., the host processor 223) may operate the electronic device based on the corrected frame. As examples, operating the electronic device based on the corrected frame may include generating output data based on the corrected frame, and/or outputting the output data. For example, outputting the output data may include generating and transmitting a response communication wirelessly from the electronic device, operating a speaker of the electronic device, operating a display of the electronic device, modifying a user interface of an application running on the electronic device, or the like.

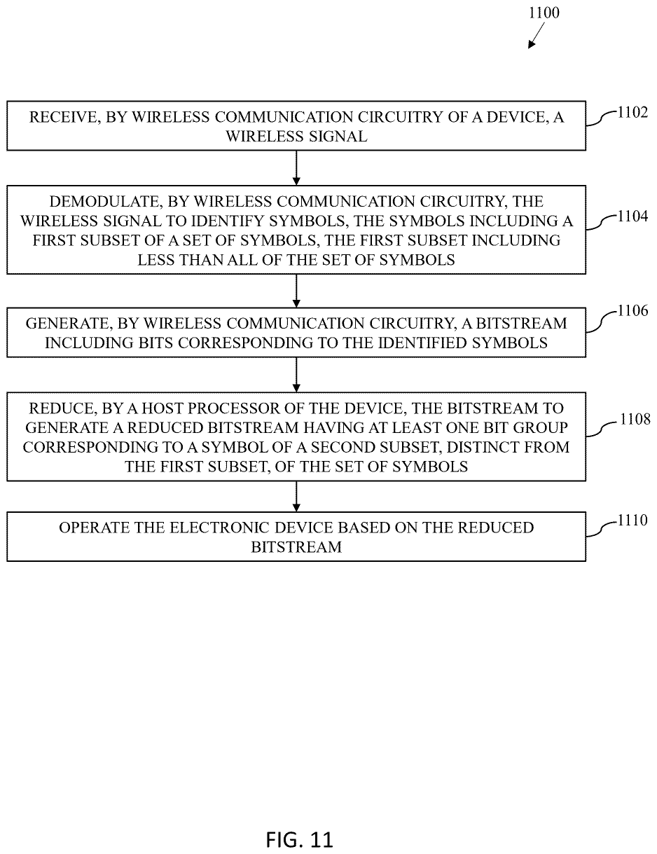

FIG. 11 is a flow chart of an example process 1100 that may be performed for range extension in accordance with one or more implementations. For explanatory purposes, the process 1100 is primarily described herein with reference to the device 220 of FIG. 2. However, the process 1100 is not limited to the device 220 of FIG, and one or more blocks (or operations) of the process 1100 may be performed by one or more other components of other suitable devices and/or servers. Further for explanatory purposes, some of the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

As illustrated in FIG. 11, at block 1102, a wireless signal may be received. The wireless signal may be received by wireless communication circuitry (e.g., wireless communication circuitry 600, including antenna 230) of a device (e.g., device 220), the wireless communication circuitry capable of identifying a set of symbols (e.g., the symbols S1-S16 of the symbol space 420).

At block 1104, the wireless communication circuitry (e.g., demodulator 604) may demodulate the wireless signal to identify a plurality of symbols. The plurality of symbols may include a first subset (e.g., a subset including only S1, S4, S13, and S16, or a subset including only S1 and S2) of the set of symbols (e.g., the symbols of the reduced symbol space 460 or the reduced symbol space 480), the first subset including less than all of the set of symbols.

At block 1106, the wireless communication circuitry (e.g., decoder 606) may generate a bitstream (e.g., modified bitstream 450 or modified bitstream 470) that includes bits (e.g., sets 452 or sets 472 of bits) corresponding to the identified plurality of symbols.

At block 1108, a host processor (e.g., host processor 223, such as a range extender 608 running on the host processor 223) of the device may reduce the bitstream to generate a reduced bitstream having at least one bit group (e.g., of bit groups 402) corresponding to a symbol of a second subset (e.g., the remaining symbols of the symbol space 420, such as S2, S3, S5-S12, S14, and S14), distinct from the first subset, of the set of symbols. For example, the reduced bitstream may correspond to an original bitstream (e.g., bitstream 400) generated by a data source at a transmitter device. The bitstream may correspond to a modified bitstream generated by another host processor at the transmitter device by modifying the original bitstream, and the host processor reducing the bitstream may reverse the modifying performed by the other host processor at the transmitter device. In one or more implementations, the host processor may reduce the bitstream responsive to receiving a range extension indicator corresponding to the wireless signal, the range extension indicator indicating the first subset of the set of symbols. In one or more implementations, the bitstream includes a plurality of bits, and the host processor may reduce the bitstream at least in part by removing at least half (e.g., half in the example of the modified bitstream 450, or three fourths in the example of the modified bitstream 470) of the plurality of bits from the bitstream. The removed bits may be duplicates of the bits in the bitstream that encode the data transmitted from a remote device (e.g., the device 210). Reducing the bitstream in this way may help to extend the range (e.g., the maximum physical distance to a transmitting device) with which the electronic device can receive accurate wirelessly transmitted information from another device (e.g., the device 210).

At block 1110, the host processor may operate the device based on the reduced bitstream. For example, operating the device based on the reduced bitstream may include generating output data corresponding to the reduced bitstream, for output from the device, and/or outputting the output data. For example, outputting the output data may include generating and transmitting a response communication wirelessly from the electronic device, operating a speaker of the electronic device, operating a display of the electronic device, modifying a user interface of an application running on the electronic device, or the like.

In one or more implementations, the process 1100 may also include determining that a frame of data obtained from the reduced bitstream fails an error check operation (e.g., as in block 1004 of FIG. 10); receiving one or more additional versions of the frame (e.g., as in block 1006 of FIG. 10); determining that the one or more additional versions of the frame fail the error check operation (e.g., as in block 1008 of FIG. 10); generating, using the frame and the one or more additional versions of the frame that fail the error check operation, a corrected frame that passes the error check operation (e.g., as in block 1010 of FIG. 10); and operating the device based on the corrected frame (e.g., as in block 1012 of FIG. 10). Generating a corrected frame in this way (e.g., in combination with reducing the bitstream) may further extend the range (e.g., the maximum physical distance to a transmitting device) with which the electronic device can receive accurate wireless transmitted information from another device.

FIG. 12 illustrates an electronic system 1200 with which one or more implementations of the subject technology may be implemented. The electronic system 1200 can be, and/or can be a part of, any one of the electronic devices 110 or 112, the end devices 152, the router 154, and/or the server 120 shown in FIG. 1. The electronic system 1200 may include various types of computer readable media and interfaces for various other types of computer readable media. The electronic system 1200 includes a bus 1208, one or more processing unit(s) 1212, a system memory 1204 (and/or buffer), a ROM 1210, a permanent storage device 1202, an input device interface 1214, an output device interface 1206, and one or more network interfaces 1216, or subsets and variations thereof.

The bus 1208 collectively represents all system, peripheral, and chipset buses that communicatively connect the numerous internal devices of the electronic system 1200. In one or more implementations, the bus 1208 communicatively connects the one or more processing unit(s) 1212 with the ROM 1210, the system memory 1204, and the permanent storage device 1202. From these various memory units, the one or more processing unit(s) 1212 retrieves instructions to execute and data to process in order to execute the processes of the subject disclosure. The one or more processing unit(s) 1212 can be a single processor or a multi-core processor in different implementations.

The ROM 1210 stores static data and instructions that are needed by the one or more processing unit(s) 1212 and other modules of the electronic system 1200. The permanent storage device 1202, on the other hand, may be a read-and-write memory device. The permanent storage device 1202 may be a non-volatile memory unit that stores instructions and data even when the electronic system 1200 is off. In one or more implementations, a mass-storage device (such as a magnetic or optical disk and its corresponding disk drive) may be used as the permanent storage device 1202.

In one or more implementations, a removable storage device (such as a flash drive, and its corresponding solid-state drive) may be used as the permanent storage device 1202. Like the permanent storage device 1202, the system memory 1204 may be a read-and-write memory device. However, unlike the permanent storage device 1202, the system memory 1204 may be a volatile read-and-write memory, such as random-access memory. The system memory 1204 may store any of the instructions and data that one or more processing unit(s) 1212 may need at runtime. In one or more implementations, the processes of the subject disclosure are stored in the system memory 1204, the permanent storage device 1202, and/or the ROM 1210. From these various memory units, the one or more processing unit(s) 1212 retrieves instructions to execute and data to process in order to execute the processes of one or more implementations.

The bus 1208 also connects to the input device interface 1214 and output device interface 1206. The input device interface 1214 enables a user to communicate information and select commands to the electronic system 1200. Input devices that may be used with the input device interface 1214 may include, for example, alphanumeric keyboards and pointing devices (also called “cursor control devices”). The output device interface 1206 may enable, for example, the display of images generated by electronic system 1200. Output devices that may be used with the output device interface 1206 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 12, the bus 1208 also couples the electronic system 1200 to one or more networks and/or to one or more network nodes, such as the electronic device 110 shown in FIG. 1, through the one or more network interface(s) 1216. In this manner, the electronic system 1200 can be a part of a network of computers (such as a LAN, a wide area network (“WAN”), or an Intranet, or a network of networks, such as the Internet. Any or all components of the electronic system 1200 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “router”, “end device”, “transceiver”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
obtaining, by an electronic device, a bitstream, wherein the electronic device comprises wireless communication circuitry configured to perform an encoding operation to map the bitstream into a symbol space comprising a first number of symbols;
identifying, by the electronic device, a range extension condition for wireless communications from the electronic device;
digitally modifying, responsive to the identifying of the range extension condition and prior to providing the bitstream to the wireless communications circuitry, the bitstream to generate a modified bitstream that maps, according to the encoding operation of the wireless communications circuitry, to a reduced symbol space comprising a second number of symbols smaller than the first number of symbols; and
providing the modified bitstream to the wireless communications circuitry for:
encoding, using the encoding operation, of the modified bitstream into the reduced symbol space comprising the second number of symbols; and
transmission of a wireless signal corresponding to the modified bitstream encoded into the reduced symbol space comprising the second number of symbols.

2. The method of claim 1, wherein the wireless communication circuitry is configured to encode, using the encoding operation, groups of a first number of bits in the bitstream into respective ones of the first number of symbols, and wherein modifying the bitstream causes the wireless communication circuitry to encode sets of the first number of bits in the modified bitstream into respective one of the second number of symbols, smaller than the first number of symbols, in the reduced symbol space.

3. The method of claim 2, further comprising, by the wireless communication circuitry:
encoding the sets of the first number of bits in the modified bitstream into the respective ones of the second number of symbols smaller than the first number of symbols;
performing an analog conversion of the respective ones of the second number of symbols for the sets of the first number of bits to generate one or more analog signals;
performing a phase modulation of the wireless signal using the one or more analog signals; and
transmitting the wireless signal.

4. The method of claim 1, wherein the first number of symbols comprises sixteen symbols, and wherein the second number of symbols comprises four symbols or two symbols.

5. The method of claim 1, wherein the wireless communication circuitry is capable of performing a first number of modulations, corresponding respectively to the first number of symbols, of a signal for wireless transmission.

6. The method of claim 1, further comprising providing an indicator of the second number of symbols to the wireless communication circuitry for transmission with the wireless signal corresponding to the modified bitstream.

7. The method of claim 1, wherein encoding, using the encoding operation, the modified bitstream into the reduced symbol space comprises encoding the modified bitstream without modifying the encoding operation, and wherein the method further comprises:
identifying, by the electronic device, an end of the range extension condition;
ceasing modifying the bitstream;
providing the bitstream, without modification, to the wireless communication circuitry; and
encoding, using the encoding operation, the bitstream into the symbol space comprising the first number of symbols.

8. The method of claim 1, wherein the range extension condition comprises a low signal strength condition or a high error rate condition.

9. The method of claim 1, wherein the range extension condition comprises an emergency mode operating condition of the electronic device.

10. The method of claim 1, wherein modifying the bitstream comprises inserting, into the bitstream adjacent a bit in the bitstream, at least one duplicate of that bit in the bitstream.

11. A method, comprising:
receiving, by an electronic device, a wireless communication comprising a frame;
determining that the frame fails an error check operation;
receiving one or more additional wireless communications including one or more additional versions of the frame;
determining that the one or more additional versions of the frame fail the error check operation;
generating, using the frame and the one or more additional versions of the frame that fail the error check operation, a corrected frame that passes the error check operation; and
operating the electronic device based on the corrected frame.

12. The method of claim 11, wherein the corrected frame is identical to an original frame transmitted by a remote device.

13. The method of claim 11, wherein the error check operation comprises a cyclic redundancy check.

14. The method of claim 11, wherein the frame and the one or more additional versions of the frame each include at least one erroneous bit.

15. The method of claim 14, wherein generating the corrected frame comprises determining a correct bit for the at least one erroneous bit in the frame or the one or more additional versions of the frame, using at least one of the frame or the one or more additional versions of the frame that includes the correct bit.

16. The method of claim 15, wherein the frame and the one or more additional versions of the frame comprise a number of frames that is equal to or greater than a total number of the erroneous bits in the frame and the one or more additional versions of the frame.

17. The method of claim 11, wherein generating the corrected frame extends a detection range of the electronic device for detecting the wireless communication.

18. A device, comprising:
wireless communication circuitry capable of identifying a set of symbols and configured to:
receive a wireless signal,
demodulate the wireless signal to identify a plurality of symbols, wherein the plurality of symbols comprises a first subset of the set of symbols, the first subset comprising less than all of the set of symbols, and
generate a bitstream comprising bits corresponding to the identified plurality of symbols; and
a host processor configured to:
reduce the bitstream to generate a reduced bitstream having at least one bit group corresponding to a symbol of a second subset, distinct from the first subset, of the set of symbols; and
operate the device based on the reduced bitstream.

19. The device of claim 18, wherein the reduced bitstream corresponds to an original bitstream generated by a data source at a transmitter device, wherein the bitstream corresponds to a modified bitstream generated by an other host processor at the transmitter device by modifying the original bitstream, and wherein the host processor reducing the bitstream reverses the modifying performed by the other host processor at the transmitter device.

20. The device of claim 19, wherein the host processor is configured to reduce the bitstream responsive to receiving a range extension indicator corresponding to the wireless signal, and wherein the range extension indicator indicates the first subset of the set of symbols.

21. The device of claim 18, wherein the bitstream comprises a plurality of bits, and wherein the host processor is configured to reduce the bitstream at least in part by removing at least half of the plurality of bits from the bitstream.

22. The device of claim 18, wherein the host processor is further configured to:
determine that a frame of data obtained from the reduced bitstream fails an error check operation;
receive one or more additional versions of the frame;
determine that =the one or more additional versions of the frame fail the error check operation;
generate, using the frame and the one or more additional versions of the frame that fail the error check operation, a corrected frame that passes the error check operation; and
operate the device based on the corrected frame.

23. The device of claim 18, wherein the host processor is configured to operate the device based on the reduced bitstream by generating output data corresponding to the reduced bitstream, for output from the device.
